(19) United States
(12) Patent Application Publication
(10) Pub. No.: US 2002/0122355 A1
(43) Pub. Date: Sep. 5, 2002

(54) Universal time zone conversion

(76) Inventor: Joseph F. Williams, Queensbury, NY (US)

Correspondence Address: ARLEN L. OLSEN, SCHMEISER, OLSEN & WATTS, 3 LEAR JET LANE, SUITE 201, LATHAM, NY, 12110, US

(21) Appl. No.: 09/757,939

(22) Filed: Jan. 10, 2001

(51) Int. Cl. G04B 19/22

(52) U.S. Cl. 368/21

(57) ABSTRACT

A method and timezone database structure for generating, storing, and using information for performing timezone-related calculations, such as flexible and efficient conversion of dates and times from one timezone to another. The timezone database structure includes a first table and a second table. The first table relates timezones to timezone identifiers. The second table relates the timezone identifiers to local shift times and associated anchor shift times. The timezone database structure may be generated for a local timezone from knowledge of: the date and time of shift in local time, the amount and direction of the shift, the Standard Time offset between the local timezone and an anchor time, and an Advanced Time offset of the local timezone relative to Standard Time.

### BACKGROUND OF THE INVENTION

1. Technical Field

The present invention relates to a method and database structure for generating, storing, and using information for flexible and efficient conversion of dates and times from one time zone to another.

2. Related Art

Increased use of globally accessed time-oriented data, such as television and radio listings, event and transportation schedules, and documents accessed over the Internet, has created a need for reliable conversion of times between time zones for systems and organizations that need to be aware of multiple versions of local time. Local time is observed consistently within prescribed areas defined both by geographic and political boundaries. Because a local governing authority is empowered to define what time line will be observed in its jurisdiction, there is no consistent formula that can be applied globally for calculating the difference in the time observed between any two separate time zones. This is further complicated by the use of Advanced Time (called Daylight Savings Time in North America and Summer Time in other parts of the world), which shifts local time ahead from Standard Time at one point in the year and subsequently shifts local time behind (i.e., returning to Standard Time) later such as approximately six months later. The precise moment of these shift times and the amount of time shifted is also determined by local political authorities and not subject to any standardized formula.

Current methods of converting local time from one time zone to another require substantial amount of data storage to account for local biases in the time shifts which are distributed through the globe. Additionally, current methods of such time conversions may involve algorithms which are complicated and difficult to maintain because of the local biases and associated complexities or subtleties. Also with current methods, storage can become unreliable because values are actually interdependent and without good validation can become out of synch, resulting in subtle inaccuracies. Thus, there is a need for a method and database structure for generating, storing, and using information for flexible and efficient conversion of dates and times from one time zone to another.

### SUMMARY OF THE INVENTION

The present invention provides a timezone database structure, comprising:

at least one timezone identifier;

at least one local shift time associated with each said timezone identifier; and

an anchor shift time associated with each said local shift time.

The present invention provides a method of generating a timezone database structure, comprising the steps of:

generating at least one timezone identifier;

generating at least one local shift time associated with each said timezone identifier; and

generating an anchor shift time associated with each said local shift time.

The present invention provides a method of using a timezone database structure to perform a timezone-related calculation, comprising the steps of:

providing the timezone database structure which includes at least one timezone identifier, at least one local shift time associated with each said timezone identifier, and an anchor shift time associated with each said local shift time; and

performing the timezone-related calculation utilizing the timezone database structure.

The present invention provides a computer system for generating a timezone database structure, comprising:

a processor;

an input device coupled to the processor;

an output device coupled to the processor;

a first memory device coupled to the processor;

a second memory device coupled to the processor; and

a computer code stored in the second memory device and executed by the processor, said computer code comprising an algorithm for generating the timezone database structure, said algorithm comprising: generating at least one timezone identifier, generating at least one local shift time associated with each said timezone identifier, and generating an anchor shift time associated with each said local shift time.

The present invention provides a computer system for using a timezone database structure to perform a timezone-related calculation, comprising:

a processor;

an input device coupled to the processor;

an output device coupled to the processor;

a first memory device coupled to the processor;

a second memory device coupled to the processor;

the timezone database structure coupled to the processor, said timezone database structure comprising: generating at least one timezone identifier, generating at least one local shift time associated with each said timezone identifier, and generating an anchor shift time associated with each said local shift time; and

a computer code stored in the first or second memory device and executed by the processor, said computer code comprising at least one algorithm, said algorithm comprising a capability for performing the timezone-related calculation utilizing the timezone database structure.

The present invention provides a method and database structure for generating, storing, and using information for flexible and efficient conversion of dates and times from one time zone to another.

The present invention may be applied to listings of television and radio programs, Internet and sporting events, and any scheduling application that covers multiple timezones and/or needs to be represented in multiple timezones in an efficient and possibly dynamic manner.

The present invention may be applied to data that is of historical value to organizations that have either changed their time-stamping methods, or have acquired additional data, and need to be able to convert the local time-stamps to some standardized time.

The present invention may be applied where official shift times may be in conflict with the scheduling needs of a particular organization.

The present invention allows user-defined timezones which can be used to adjust local time shifts (e.g., automated scheduling applications for cable TV system pay-per-view servers which often need to shift, for example, at 6:00 AM in North America instead of at 2:00 AM).

### BRIEF DESCRIPTION OF THE DRAWINGS

FIG. 1 depicts an example of a Timezone Definition Table, in accordance with embodiments of the present invention.

FIG. 2 depicts a Shift Times Table associated with the Timezone Definition Table of FIG. 1, in accordance with embodiments of the present invention.

FIG. 3 depicts a computer system that includes algorithms for generating and storing a timezone database structure, and for utilizing the timezone database structure to perform timezone-related calculations, in accordance with embodiments of the present invention.

### DETAILED DESCRIPTION OF THE INVENTION

A time zone (“timezone”) is a geographical area in which there is a geographically uniform standard for designating local time. Local time of a timezone is the clock time as seen by an observer in the timezone. Local time of a timezone is measured relative to an “anchor” location. For example, a commonly used anchor location is Greenwich, United Kingdom. Local time is characterized, in part, by Standard Time offsets with respect to the anchor location. For example, the United States includes, inter alia, Eastern, Central, Western, and Pacific timezones which have Standard Time offsets relative to the anchor location (i.e., Greenwich) of 5 hours, 6 hours, 7 hours, and 8 hours, respectively, prior to Greenwich time.

A timezone is either “observing” or “non-observing.” An observing timezone has a local time shift at a plurality of points in chronological time. A local time shift advances or reverses the local time, or “clock time,” in the timezone. If the local time shift advances the clock time, then subsequent time is designated as “Advanced Time.” An example of Advanced Time in parts of North America is Daylight Savings Time. If the local time shift reverses the clock time, then subsequent time is designated as Standard Time. An observing timezone is characterized by discrete chronological times at which a local time shift occurs. Thus, local time in an observing timezone at a given date and time (“date-time”) is determined by its Standard Time offset with respect to the anchor location and also by whether the Standard Time or Advanced Time is in effect at the given date-time.

A non-observing timezone has no local time shifts. Thus, local time in a non-observing timezone at any date-time is determined by its Standard Time offset with respect to the anchor location.

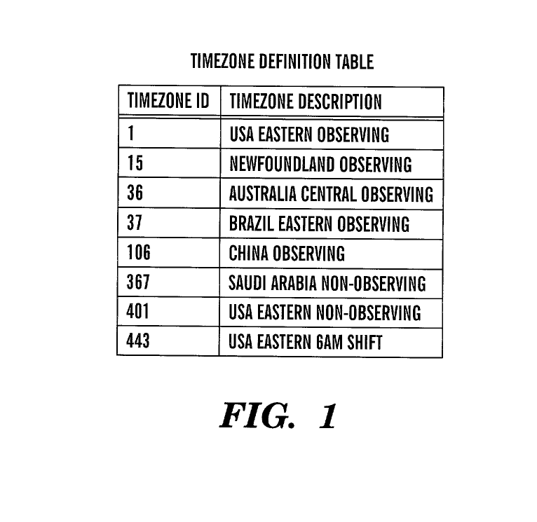

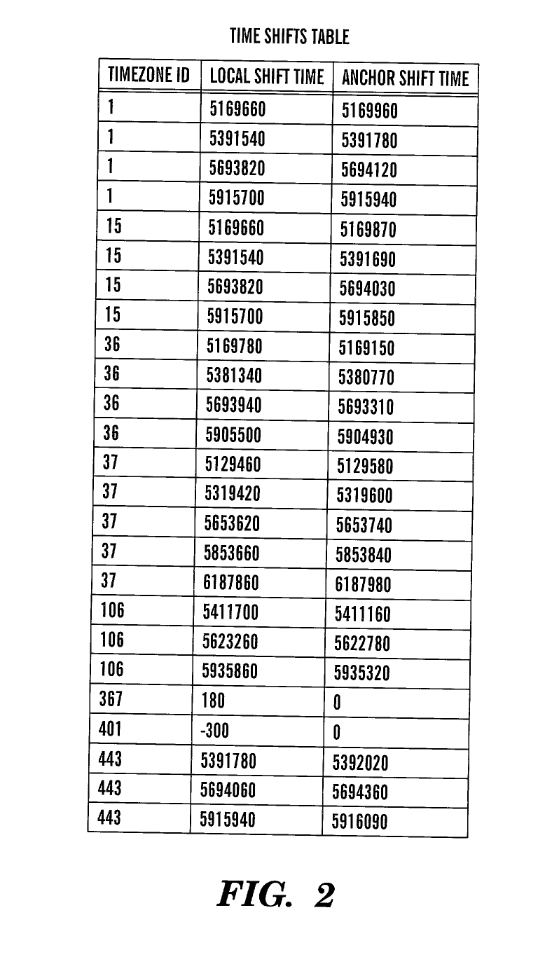

The present invention discloses a timezone database structure comprising a first table and a second table. The first table is a Timezone Definition Table, and the second table is a Shift Times Table. FIG. 1 depicts an example of a Timezone Definition Table, in accordance with embodiments of the present invention. FIG. 2 depicts a Shift Times Table associated with the Timezone Definition Table of FIG. 1, in accordance with embodiments of the present invention.

The Timezone Definition Table, as illustrated by FIG. 1, has a Timezone Identifier (“Timezone ID”) column which includes timezone identifiers, and a Timezone Description column which describes geographical areas associated with the timezones. Each entry of the Timezone ID column is a symbol which identifies a timezone. While such symbols are shown as integers in the Timezone ID column of FIG. 1, such symbols may be in any format such as, inter alia, a character format. An entry in the Timezone Description column at a given row describes the geographical area that is identified with the timezone in the Timezone ID column at the given row. The Timezone Description column also denotes whether the associated timezone is observing or non-observing. The indication in the Timezone Description column of whether the associated timezone is observing or non-observing is for convenience only and is not logically required. The Timezone Definition Table may include user-defined timezones as illustrated by the timezone ID 443 in FIG. 1 which is characterized by a user-defined shift time of 6:00 AM in a USA Eastern timezone. A user-defined shift time of 6:00 AM means that the user turns the clock backward from 6:00 AM to 5:00 AM when transitioning from Advanced Time to Standard Time, and the turns the clock forward from 6:00 AM to 7:00 AM when transitioning from Standard Time to Advanced Time. The Timezone Definition Table may be generated by any method of inserting, generating, updating, or modifying data entries for the timezone identifiers and the associated timezone descriptions, such as by, inter alia, manual entry or computer generation.

The Shift Times Table, as illustrated by FIG. 2, has a Timezone ID column, a Local Shift Time column, and an Anchor Shift Time column. The Shift Times Table (e.g., FIG. 2) has an assumed anchor location and an assumed reference date-time. The reference date-time is a date-time at an arbitrary reference location. As a special case, the reference location could be the anchor location. The Local Shift Time column and an Anchor Shift Time column include times which are relative to the reference date-time. In the Shift Times Table of FIG. 2, the anchor location is Greenwich United Kingdom, and the reference date-time is Jan. 1, 1990 at midnight at Greenwich, United Kingdom. In FIG. 2, the local shift times and anchor shift times are expressed in minutes since Jan. 1, 1990.

In FIG. 2, the Timezone ID column in the Shift Times Table is the same as the Timezone ID column in the Timezone Definition Table. An entry in the Local Shift Time column in a given row includes a local shift time for the timezone in the Timezone ID column in the given row. A local shift time is a time when a local time shift occurs as perceived by one in the timezone immediately following the advance or reversal of clock time that accompanies the local time shift. For example, the Timezone Definition Table shows a local shift time of 5693820 for timezone ID 1, which corresponds to 1:00 AM on Oct. 29, 2000 in the Eastern Observing timezone. The local shift time of 5693820 pertains to 1:00 AM after the clock had reached 2:00 AM in the Eastern Observing timezone and was turned back one hour in a transition from Daylight Savings Time to Standard Time.

The local shift time is relative to the reference date-time, and a local shift time may pertain to a time that is before or after the reference date-time. The local shift times may be in any format or datatype that can be used to establish an order of chronology of the local shift times, such as, inter alia, integer format, floating point format, octal format, hexadecimal format, binary format, and character format. An integer format or floating point format may include elapsed time from the reference date-time or any other fixed date-time. Time may be expressed to any degree of resolution; e.g., minutes, seconds, milliseconds, microseconds, etc. In the Shift Times Table (e.g., FIG. 2), the local shift time is expressed in minutes in integer format and may be calculated as 1440D+M, where D is the number of days that elapsed since Jan. 1, 1990, and M is the number of minutes between midnight and when the local time shift occurs on the date of the local time shift. Note that commercial software is generally available for calculating D and M, or 1440D+M, from a given date-time, and vice versa.

In FIG. 2, an entry in the Anchor Shift Time column in a given row includes an anchor shift time that is associated with the local shift time in the Local Shift Time column in the given row. An anchor shift time is an elapsed time at the anchor location since the reference date-time. The anchor shift time is relative to the reference date-time and may be in any format or datatype that can be used to establish an order of chronology of the anchor shift times, such as, inter alia, integer format, floating point format, octal format, hexadecimal format, binary format, and. In the Shift Times Table (e.g., FIG. 2), the anchor shift time is expressed in minutes in integer format.

While the preceding discussion of the Shift Times Table (e.g., FIG. 2) applies to observing timezones, the Shift Times Table (e.g., FIG. 2) may also include non-observing timezones. A non-observing timezone is represented in one row in the Shift Times Table. See, e.g., the timezones having timezone identifiers 367 and 401 in FIG. 2. Since a non-observing timezone has no local time shifts, the anchor shift time in the Shift Times Table (e.g., FIG. 2) of the non-observing timezone is arbitrary, which means that the anchor shift time may correspond to any arbitrarily chosen date-time at the anchor location relative to the reference date-time. The associated local shift time in the Shift Times Table (e.g., FIG. 2) for the non-observing timezone is not a shift time but is rather the arbitrarily chosen date-time at the anchor location incremented by the time offset of the non-observing timezone with respect to the anchor location. Generally, a difference between the local shift time and the associated anchor shift time is the time offset of the local time of the timezone with respect to the anchor location, regardless of whether the timezone is observing or non-observing. Thus, algorithms to be described infra for using the Shift Times Table (e.g., FIG. 2) are valid regardless of whether a timezone used by any such algorithm is observing or non-observing. By using a value of 0 for the timezone 401 in the Shift Times Table (e.g., FIG. 2), the arbitrarily chosen date-time of the anchor shift time for the timezone 401 is the reference date-time, namely Jan. 1, 1990 at midnight at Greenwich, United Kingdom, and the associated local shift time of −300 minutes (equivalent to 5 hours west of Greenwich) is the time offset for the timezone 401.

For a given timezone identifier in the Shift Times Table (e.g., FIG. 2), the local shift times may be in sorted order (e.g., in ascending order or in descending order), or in unsorted order.

The Shift Times Table of the present invention advantageously stores a minimal amount of information necessary to describe all possible differences between any two local times.

The timezone database structure may be generated and used as described infra.

Generating the Timezone Database Structure

The Timezone Definition Table and the Shift Times Table may be generated by any method of inserting or generating data for the timezone identifiers, local shift time, and anchor shift time of each timezone, such as by, inter alia, manual entry or computer generation. The present invention discloses the following Local/Anchor Shift Time (LAST) algorithm to generate the Shift Times Table. The LAST algorithm computes a local shift time (LST) and an associated anchor shift time (AST) associated with a time shift for a given timezone in a row of the Shift 20 Times Table. Inputs for computing LST and AST may include:

LT=local time immediately before a time shift for which a local shift time value is to be generated;

ST_{OFFSET}=Standard Time offset; i.e., offset of the timezone relative to the anchor location;

AT_{OFFSET}=Advanced Time offset of the timezone relative to Standard Time; and

whether the shift is from Standard Time to Advanced Time, or vice versa.

If the timezone is non-observing, then AST is arbitrary (e.g., AST=0) and LST=AST+ST_{OFFSET}. As an example, ST_{OFFSET}=180 minutes for the Saudi Arabia Non-Observing timezone in FIGS. 1 and 2. If AST=0 is chosen, then LST=0+180=180 minutes as shown in FIG. 2. As another example, ST_{OFFSET}=−300 minutes for the USA Eastern Non-Observing timezone as shown in FIG. 2. Noting that AST is arbitrary if the timezone is non-observing, and if AST=1000 is chosen, then LST=1000+(−300)=700 minutes. Alternatively AST=0 could have been chosen for the USA Eastern Non-Observing timezone, which would result in LST=0+(−300)=−300 as shown in FIG. 2.

If the timezone is observing, then:

LST=LT+Δ_{LST} (1)

AST=LST−ST_{OFFSET}+Δ_{AST} (2)

$$\begin{matrix}where {Δ}_{LST} = + {AT}_{OFFSET} & if the shift is from Standard Time \\ & to Advanced Time \\ = - {AT}_{OFFSET} & if the shift is from Advanced Time \\ & to Standard Time \\ and {Δ}_{AST} = - {AT}_{OFFSET} & if the shift is from Standard Time \\ & to Advanced Time \\ = 0 & if the shift is from Advanced Time \\ & to Standard Time\end{matrix}$$

The LAST algorithm includes all algebraic variants thereof. For example, Equation (2) could be rewritten as: AST=LT−ST_{OFFSET}+Δ_{LST}+Δ_{AST}.

As an example, a traditional shift time on Oct. 29, 2000 at 2:00 AM in the Eastern Observing timezone is to be converted to LST and AST as follows. It is assumed that the anchor location is Greenwich, United Kingdom, and that the reference date-time is Jan. 1, 1990 at midnight at Greenwich, United Kingdom. In the Eastern Observing timezone: ST_{OFFSET}=−300 minutes, AT_{OFFSET}=60 minutes. Moreover the shift on Oct. 29, 2000 at 2:00 AM is from Advanced Time to Standard Time. Then,

Given date-time in Eastern Standard Observing=Oct. 29, 2000 at 2:00 AM

LT₁=5693880 (from Oct. 29, 2000 at 2:00 AM)

Δ_{LST}=−60 (from definition of Δ_{LST})

Δ_{AST}=0 (from definition of Δ_{AST})

LST=5693880+(−60)=5693820 (from Equation (1))

AST=5693820−(−300)+0=5694120 (from Equation (2)).

As another example, a traditional shift time on Apr. 1, 2001 at 2:00 AM in the Eastern Observing timezone is to be converted to LST and AST as follows. It is assumed that the anchor location is Greenwich, United Kingdom, and that the reference date-time is Jan. 1, 1990 at midnight at Greenwich, United Kingdom. In the Eastern Observing timezone: ST_{OFFSET}=−300 minutes, AT_{OFFSET}=60 minutes. Moreover the shift on Apr. 1, 2001 at 2:00 AM is from Standard Time to Advanced Time. Then,

Given date-time in Eastern Standard Observing=Apr. 1, 2001 at 2:00 AM

LT₁=5915640 (from Apr. 1, 2001 at 2:00 AM)

Δ_{LST}=+60 (from definition of Δ_{LST})

Δ_{AST}=−60 (from definition of Δ_{AST})

LST=5915640+60 =5915700 (from Equation (1))

AST=5915700−(−300)+(−60)=5915940 (from Equation (2)).

In addition to being initially generated, the Timezone Definition Table and the Shift Times Table may be updated or otherwise modified. Generating the Timezone Definition Table includes modifying the Timezone Definition Table, such as by, inter alia, adding a timezone identifier or deleting a timezone identifier. Thus, generating the Shift Times Table includes modifying the Shift Times Table in accordance with any timezone identifier added or deleted by said modifying of the Timezone Definition Table.

Generating the Shift Times Table also includes adding a new timezone identifier and associated data, wherein the associated data includes associated local shift time data and associated anchor shift time data. Additionally, generating the Shift Times Table includes adding additional local shift time data and associated anchor shift time data for a timezone identifier that already exists in the Shift Times Table. Furthermore, generating the Shift Times Table includes replacing a timezone identifier with a replacement timezone identifier, replacing a local shift time with a replacement local shift time, replacing an anchor shift time with a replacement anchor shift time, or combinations thereof.

The timezone database structure may be used to perform a timezone-related calculation.

In particular, the Shift Times Table of the timezone database structure may be utilized for performing the timezone-related calculation. Such timezone-related calculations include, inter alia, a conversion of a local time of a first timezone to a local time of a second timezone, “double time” calculations, a determination of whether a local time is in Advanced Time, and “lost time” calculations.

Converting a Local Time of a First Timezone to a Local Time of a Second Timezone

Let

LT₁=local time in timezone 1

AT₁=anchor time associated with LT₁

LST₁=latest local shift time in timezone that is not later than LT₁

AST₁=anchor shift time associated with LST₁

LT₂=local time in timezone 2 that is equivalent to LT₁

AT₂=anchor time associated with LT₂

AST₂=anchor shift time in timezone 2 that is not later than AT₂

LST₂=local shift time in timezone 2 that is associated with AT₂

The following algorithm, called a Local Time Conversion (LTC) algorithm, calculates LT₂, given LT₁ and a timezone database structure. From the given LT₁, the shift time of LST₁ and the associated AST₁ are determined from the Shift Times Table of the timezone database structure in accordance with the preceding definitions of LST₁ and AST₁. Then AT₁ and AT₂ are calculated according to:

AT₁=LT₁−(LST₁−AST₁) (3)

AT₂=AT₁ (4)

From AT₂, the shift time of AST₂ and the associated LST₂ are determined from the Shift Times Table of the timezone database structure in accordance with the preceding definitions of AST₂ and LST₂. Then LT₂ is calculated according to:

LT₂=AT₂+(LST₂−AST₂) (5)

The LTC algorithm is correct regardless of whether the first timezone is observing or non-observing, and regardless of whether the second timezone is observing or non-observing, as illustrated in the following examples.

In a first example, the first timezone is USA Eastern Observing (timezone ID 1) and the second timezone is Newfoundland Observing (timezone ID 15), with a date time corresponding to LT₁ of Oct. 29, 2000 at 4:00 PM in USA Eastern Observing. It is assumed that the an anchor location is Greenwich, United Kingdom, and that the reference date-time is Jan. 1, 1990 at midnight at Greenwich, United Kingdom. Then,

Given date-time in USA Eastern Observing=Oct. 29, 2000 at 4:00 PM

LT₁=5694000 (from Oct. 29, 2000 at 4:00 PM)

LST₁=5693820 (from Shift Times Table of FIG. 2 for timezone ID 1)

AST₁=5694120 (from Shift Times Table of FIG. 2 for timezone ID 1)

AT₁=5694000−(5693820−5694120)=5694300 (from Equation (3))

AT₂=5694300 (from Equation (4))

AST₂=5694030 (from Shift Times Table of FIG. 2 for timezone ID 15)

LST₂=5693820 (from Shift Times Table of FIG. 2 for timezone ID 15)

LT₂=5694300+(5693820−5694030)=5694090 (from Equation (5))

Calculated date-time in Newfoundland Observing=Oct. 29, 2000 at 5:30 AM (from LT₂)

In a second example, the first timezone is Australia Central Observing (timezone ID 36) and the second timezone is Saudi Arabia Non-Observing (timezone ID 367), with a date time corresponding to LT₁ of Oct. 29, 2000 at 6:00 AM in Australia Central Observing. It is assumed that the an anchor location is Greenwich, United Kingdom, and that the reference date-time is Jan. 1, 1990 at midnight at Greenwich, United Kingdom. Then,

Given date-time in Australia Central Observing=Oct. 29, 2000 at 6:00 AM

LT₁=5694120 (from Oct. 29, 2000 at 6:00 AM)

LST₁=5693940 (from Shift Times Table of FIG. 2 for timezone ID 36)

AST₁=5693310 (from Shift Times Table of FIG. 2 for timezone ID 36)

AT₁=5694120−(5693940−5693310)=5693490 (from Equation (3))

AT₂=5693490 (from Equation (4))

AST₂=0 (from Shift Times Table of FIG. 2 for timezone ID 367)

LST₂=180 (from Shift Times Table of FIG. 2 for timezone ID 367)

LT₂=5693490+(180−0)=5693670 (from Equation (5))

Calculated date-time in Saudi Arabia Non-Observing=Oct. 28, 2000 at 10:30 PM (from LT₂).

In a third example, the first timezone is Saudi Arabia Non-Observing (timezone ID 367), and the second timezone is Australia Central Observing (timezone ID 36), with a date time corresponding to LT₁ of Oct. 28, 2000 at 10:30 PM in Saudi Arabia Non-Observing. It is assumed that the an anchor location is Greenwich, United Kingdom, and that the reference date-time is Jan. 1, 1990 at midnight at Greenwich, United Kingdom. Then,

Given date-time in Saudi Arabia Non-Observing=Oct. 28, 2000 at 10:30 PM

LT₁=5693670 (from Oct. 28, 2000 at 10:30 PM)

LST₁=180 (from Shift Times Table of FIG. 2 for timezone ID 367)

AST₁=0 (from Shift Times Table of FIG. 2 for timezone ID 367)

AT₁=5693670−(180−0)=5693490 (from Equation (3))

AT₂=5693490 (from Equation (4))

AST₂=5693310 (from Shift Times Table of FIG. 2 for timezone ID 36)

LST₂=5693940 (from Shift Times Table of FIG. 2 for timezone ID 36)

LT₂=5693490+(5693940−693310)=5694120 (from Equation (5))

Calculated date-time in Australia Central Observing=Oct. 29, 2000 at 6:00 AM

In a fourth example, the first timezone is Saudi Arabia Non-Observing (timezone ID 367), and the second timezone is USA Eastern Non-Observing (timezone ID 401), with a date time corresponding to LT₁ of Oct. 29, 2000 at 11:00 AM in Saudi Arabia Non-Observing. It is assumed that the an anchor location is Greenwich, United Kingdom, and that the reference date-time is Jan. 1, 1990 at midnight at Greenwich, United Kingdom. Then,

Given date-time in Saudi Arabia Non-Observing=Oct. 29, 2000 at 11:00 AM

LT₁=5694420 (from Oct. 29, 2000 at 11:00 AM)

LST₁=180 (from Shift Times Table of FIG. 2 for timezone ID 367)

AST₁=0 (from Shift Times Table of FIG. 2 for timezone ID 367)

AT₁=5694420−(180−0)=5694240 (from Equation (3))

AT₂=5694240 (from Equation (4))

AST₂=0 (from Shift Times Table of FIG. 2 for timezone ID 401)

LST₂=−300 (from Shift Times Table of FIG. 2 for timezone ID 401)

LT₂=5694240+(−300−0)=5693940 (from Equation (5))

Calculated date-time in USA Eastern Non-Observing=Oct. 29, 2000 at 3:00 AM

In a fifth example, the first timezone is USA Eastern Non-Observing (timezone ID 401) and the second timezone is USA Eastern Observing with a user-defined shift time of 6:00 AM (timezone ID 443), with a date time corresponding to LT₁ of Oct. 29, 2000 at 4:00 AM in USA Eastern Non-Observing. It is assumed that the an anchor location is Greenwich, United Kingdom, and that the reference date-time is Jan. 1, 1990 at midnight at Greenwich, United Kingdom. Then,

Given date-time in USA Eastern Non-Observing=Oct. 29, 2000 at 4:00 AM

LT₁=5694000 (from Oct. 29, 2000 at 4:00 AM)

LST₁=−300 (from Shift Times Table of FIG. 2 for timezone ID 401)

AST₁=0 (from Shift Times Table of FIG. 2 for timezone ID 401)

AT₁=5694000−(−300−0)=5694300 (from Equation (3))

AT₂=5694300 (from Equation (4))

AST₂=5392020 (from Shift Times Table of FIG. 2 for timezone ID 443)

LST₂=5391780 (from Shift Times Table of FIG. 2 for timezone ID 443)

LT₂=5694300+(5391780−5392020)=5694060 (from Equation (5))

Calculated date-time in USA Eastern 5 AM Shift Time=Oct. 29, 2000 at 6:00 AM (from LT₂)

The LTC algorithm includes all algebraic variants thereof.

Double Time Calculations

To convert from local time in an observing timezone, it is necessary to determine whether that time is a “double time”; i.e., a time range that will be repeated when shifting back to Standard Time. The “double time” period is the last period in an Advanced Time segment that is as long as the differential between Advanced and Standard Time. In the United States, this differential is one hour. For timezones in the United States, “double time” can be described as the last hour of Daylight Savings Time. Thus, a given date-time is in double time if the given date-time is in the last hour segment before a switch occurs from Advanced Time to Standard Time.

As an example of an application of double time, consider the USA Eastern Observing timezone in which the clock is turned back 1 hour at 2:00 AM (i.e., the clock is turned back from 2:00 AM to 1:00 AM) on Oct. 29, 2000. If a computer user in the USA Eastern Observing timezone inputs to computer software a date-time of 1:30 AM on Oct. 29, 2000, then the computer software has no way of knowing whether the 1:30 AM relates to before or after the clock has been turned back 1 hour. Thus, if the computer software has a way of determining that the inputed 1:30 AM on Oct. 29, 2000 could be in double time, then the computer software could query the user as to whether the 1:30 AM on Oct. 29, 2000 actually is in double time. Then if the user responds that the 1:30 AM on Oct. 29, 2000 is in double time (i.e., before the clock has been turned back), then the computer software could compute the anchor time associated with 1:30 AM on Oct. 29, 2000 in the normal manner and then adjust the computed anchor time by subtracting a double time offset (DT_{OFFSET}), defined supra. The DT_{OFFSET} may be known explicitly or could be calculated from the Shift Times Table as will be described supra.

The following Double Time Test (DTT) algorithm may be used to determine whether a given date-time in an observing timezone could be in double time.

Let

LT=local time in the timezone associated with the given date-time

AT=anchor time associated with LT

LST₁=latest local shift time in the timezone that is not later than LT

AST₁=anchor shift time associated with LST₁

LST₀=latest local shift time in the timezone before LST₁

AST₀=anchor shift time associated with LST₀

The DTT algorithm first determines LT from knowledge of the given date-time. Next, a parameter Δ is computed according to:

Δ=(AST₁−LST₁)−(AST₀−LST₀) (6)

Then LT is tested against LST₁+Δ. If LT≧LST₁+Δ, or if LT<LST₁+Δ (i.e., the given date-time could be in double time) and it is further determined (such as by user response to a query) that the given date-time is not in double time, then the given date-time is not be in double time and AT is computed in the normal manner as:

AT=LT−(LST₁−AST₁) (7)

If LT<LST₁+Δ (i.e., the given date-time could be in double time) and it is further determined (such as by user response to a query) that the given date-time actually is in double time, then the given date-time is in double time and AT is computed according to:

AT=LT−(LST₁−AST₁)−DT_{OFFSET} (8)

where the “double-time offset” DT_{OFFSET} is calculated according to:

DT_{OFFSET=Δ} (9)

As an example of performing double time calculations according to the DTT algorithm, consider a given date-time of Sep. 10, 2000 at 1:30 AM in the China Observing timezone (timezone ID 106). Whether the given date-time could be a double time is determined by the DTT algorithm as follows.

LT=5623290 (from Sep. 10, 2000 at 1:30 AM)

LST₁=5623260 (from Shift Times Table of FIG. 2 for timezone ID 106)

AST₁=5622780 (from Shift Times Table of FIG. 2 for timezone ID 106)

LST₀=5411700 (from Shift Times Table of FIG. 2 for timezone ID 106)

AST₀=5411160 (from Shift Times Table of FIG. 2 for timezone ID 106)

Δ=60 (from Equation (6))

LST₁+Δ=5623320

Thus, LT<LST₁+Δ, and the given date-time could be in double time. If it is further determined (such as by user response to a query) that the given date-time is not in double time, then AT is computed according to Equation (7); i.e., AT=5623290−(5623260−5622780)=5622810. If, on the other hand, it is further determined (such as by user response to a query) that the given date-time actually is in double time, then AT is computed according to Equations (8)-(9); i.e., AT=5623290−(5623260−5622780)−60=5622750.

The DTT algorithm includes all algebraic variants thereof.

Determination of Whether a Local Time is in Advanced Time

For a given date-time in an observing timezone, a determination of whether the given date-time is in Advanced Time may be determined by an Advanced Time Test (ATT) algorithm as follows. Using the same notation as with the DTT algorithm,

let

LT=local time in the timezone associated with the given date-time

AT=anchor time associated with LT

LST₁=latest local shift time in the timezone that is not later than LT

AST₁=anchor shift time associated with LST₁

LST₀=latest local shift time in the timezone that before LST₁

AST₀=anchor shift time associated with LST₀

The ATT algorithm first determines LT from knowledge of the given date-time. Next, the parameter Δ is computed according to:

Δ=(AST₁−LST₁)−(AST₀−LST₀) (9)

If Δ<0, then the given date-time is in Advanced Time. If Δ>0, then the given date-time is in Standard Time, unless the given date-time is in double time. Whether the given date-time is in double time may be determined by the DTT algorithm, described supra and hereby incorporated for this purpose into the ATT algorithm.

As an example of using the ATT algorithm, consider a given date-time of Oct. 29, 2000 at 3:30 AM in the Eastern Observing timezone (timezone ID 1). Whether the given date-time is in Advanced Time is determined by the ATT algorithm as follows.

LT=5693970 (from Oct. 29, 2000 at 3:30 AM)

LST₁=5693820 (from Shift Times Table of FIG. 2 for timezone ID 1)

AST₁=5694120 (from Shift Times Table of FIG. 2 for timezone ID 1)

LST₀=5391540 (from Shift Times Table of FIG. 2 for timezone ID 1)

AST₀=5391780 (from Shift Times Table of FIG. 2 for timezone ID 1)

Δ=60 (from Equation (9))

Since Δ>0, the given date-time is in Standard Time, unless the given date-time is in double time. Noting that LST₁+Δ=5693880 and therefore that LT>LST₁+Δ, it follows from the DTT algorithm that the given date-time is not in double time. Accordingly, the given date-time is in Standard Time.

As another example of using the ATT algorithm, consider a given date-time of Oct. 29, 2000 at 12:30 AM in the Eastern Observing timezone (timezone ID 1). Whether the given date-time is in Advanced Time is determined by the ATT algorithm as follows.

LT=5693790 (from Oct. 29, 2000 at 12:30 AM)

LST₁=5391540 (from Shift Times Table of FIG. 2 for timezone ID 1)

AST₁=5391780 (from Shift Times Table of FIG. 2 for timezone ID 1)

LST₀=5169660 (from Shift Times Table of FIG. 2 for timezone ID 1)

AST₁=5169960 (from Shift Times Table of FIG. 2 for timezone ID 1)

Δ=−60 (from Equation (9))

Since Δ<0, the given date-time is in Advanced Time.

The ATT algorithm includes all algebraic variants thereof.

Lost Time Calculations

To convert from local time in an observing timezone, it may be necessary to determine whether that time is in “lost time”; i.e., a time range that will be never be put into effect when shifting forward to Advanced Time. The “lost time” period is a clock time interval that is skipped when a transition is made from Standard Time to Advanced Time. The “lost time” period is as long as the differential between Advanced and Standard Time. In the United States, this differential is one hour. For timezones in the United States, “lost time” can be described as an hour that is skipped when transitioning from Standard Time to Daylight Savings Time. Thus, a given date-time is in lost time if the given date-time is in said skipped clock time interval.

As an example of an application of lost time, consider the USA Eastern Observing timezone in which the clock is turned forward 1 hour at 2:00 AM (i.e., the clock is turned forward from 2:00 AM to 3:00 AM) on Apr. 1, 2001. If a computer user in the USA Eastern Observing timezone inputs to computer software a date-time of 2:30 AM on Apr. 1, 2001, then the indicated time of 2:30 AM on Apr. 1, 2001 should be considered as erroneous input by the computer software, because 2:30 AM on Apr. 1, 2001 is in “lost time” and thus does not exist. Thus, the computer software needs to have a method of determining that the inputed 2:30 AM on Apr. 1, 2001 is in lost time, so that the computer software could inform the computer user that the inputed date-time of 2:30 AM on Apr. 1, 2001 is erroneous.

The following Lost Time Test (LTT) algorithm may be used to determine whether a given date-time in an observing timezone is in lost time.

Let

LT=local time in the timezone associated with the given date-time

LST₁=latest local shift time in the timezone that is not later than LT

AST₁=anchor shift time associated with LST₁

LST₊=earliest local shift time in the timezone after LST₁

AST₁₊=anchor shift time associated with LST₁₊

The LTT algorithm first determines LT from knowledge of the given date-time. Next, a parameter δ is computed according to:

δ =(AST₁−LST₁)−(AST₁₊−LST₁₊) (10)

Then LT is tested against LST₁₊−δ. If LT>LST₁₊−δ, then LT is in lost time; else LT is not in lost time. In effect, the LTT algorithm assesses whether LT is in the “lost time” interval immediately preceding LST₁₊.

As an example of performing lost time calculations according to the LTT algorithm, consider a given date-time of 2:30 AM on Apr. 1, 2001 in the USA Eastern Observing timezone (timezone ID 1). Whether the given date-time is in lost time is determined by the LTT algorithm as follows.

LT=5915670 (from Apr. 1, 2001 at 2:30 AM)

LST₁=5693820 (from Shift Times Table of FIG. 2 for timezone ID 1)

AST₁=5694120 (from Shift Times Table of FIG. 2 for timezone ID 1)

LST₁₊=5915700 (from Shift Times Table of FIG. 2 for timezone ID 1)

AST₁₊=5915940 (from Shift Times Table of FIG. 2 for timezone ID 1)

δ=60 (from Equation (10))

LST₁₊−δ=5915640

Thus, LT>LST₁₊×δ, and the given date-time is therefore in lost time.

The LTT algorithm includes all algebraic variants thereof.

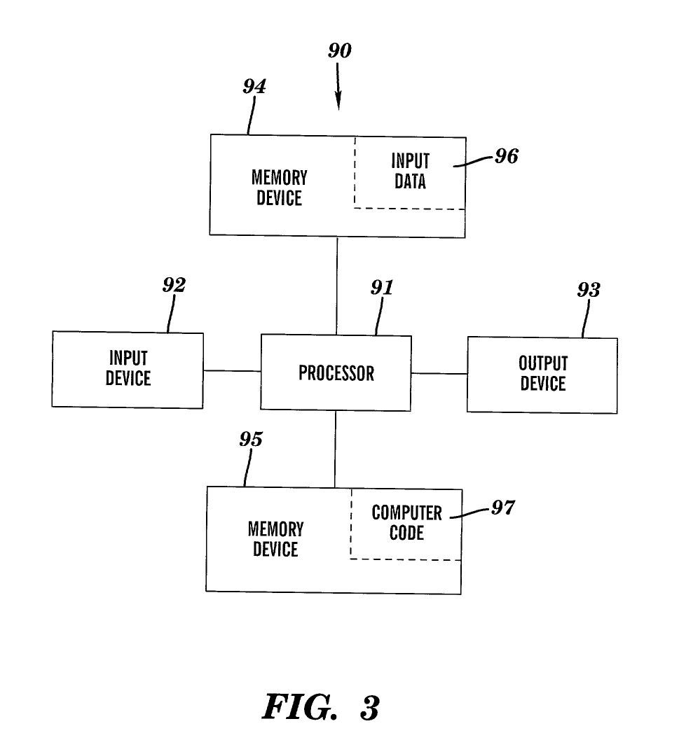

FIG. 3 depicts a computer system 90 that includes algorithms for generating and storing a timezone database structure, and for utilizing the timezone database structure to perform timezone-related calculations, in accordance with embodiments of the present invention. The computer system 90 comprises a processor 91, an input device 92 coupled to the processor 91, an output device 93 coupled to the processor 91, and memory devices 94 and 95 each coupled to the processor 91. The input device 92 may be, inter alia, a keyboard, a mouse, etc. The output device 93 may be, inter alia, a printer, a plotter, a computer screen, a magnetic tape, a removable hard disk, a floppy disk, etc. The memory devices 94 and 95 may be, inter alia, a hard disk, a dynamic random access memory (DRAM), a read-only memory (ROM), etc. The memory device 95 includes a computer code 97. The computer code 97 includes a generational algorithm (e.g., the LAST algorithm) for generating the timezone database structure of the present invention. The timezone database structure may be stored in the memory device 94 or the memory device 95, or both. The computer code 97 also includes calculational algorithms for performing timezone-related calculations. Such calculational algorithms may include, inter alia, a LTC algorithm, a DTT algorithm, an ATT algorithm, and a LTT algorithm. The processor 91 executes the computer code 97. The memory device 94 includes input data 96. The input data 96 includes input required by the computer code 97. The output device 93 displays output from the computer code 97. In particular, the output device 93 includes the output medium and displays the output structure of the present invention on the output medium.

While FIG. 3 shows the computer system 90 as a particular configuration of hardware and software, any configuration of hardware and software, as would be known to a person of ordinary skill in the art, may be utilized for the purposes stated supra in conjunction with the particular computer system 90 of FIG. 3. For example, the memory devices 94 and 95 may be portions of a single memory device rather than separate memory devices.

While the timezone database structure, as described herein, includes a Timezone Definition Table and a Shift Times Table, the scope of the present invention generally includes any timezone database structure that includes: at least one timezone identifier, at least one local shift time associated with each such timezone identifier, and an anchor shift time associated with each such local shift time. Such timezone database structures comprise databases in any form having database functionality that may be used with the methods and algorithms described herein. Such database structures comprise, inter alia, relational databases, non-relational databases, spreadsheets, data structures within computer codes, data files formatted as tables, etc.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

We claim:

1. A timezone database structure, comprising:
at least one timezone identifier;
at least one local shift time associated with each said timezone identifier; and
an anchor shift time associated with each said local shift time.

2. The database structure of claim 1, wherein the local shift times associated with a given timezone identifier of the at least one timezone identifier are in sorted order.

3. The database structure of claim 1, wherein the local shift times associated with a given timezone identifier of the at least one timezone identifier are in unsorted order.

4. The database structure of claim 1, wherein a timezone associated with a timezone identifier of the at least one timezone identifier is non-observing.

5. The database structure of claim 1, wherein a timezone associated with a first timezone identifier of the at least one timezone identifier is observing.

6. The database structure of claim 5, wherein a timezone associated with a second timezone identifier of the at least one timezone identifier is non-observing.

7. The database structure of claim 1, wherein a first local shift time associated with a first timezone identifier of the at least one timezone identifier is relative to a reference date-time.

8. The database structure of claim 7, wherein the first local shift time is after the reference date-time.

9. The database structure of claim 7, wherein the first local shift time is before the reference date-time.

10. The database structure of claim 9, wherein a second local shift time associated with the first timezone identifier is relative to the reference date-time, and wherein the second local shift time is after the reference date-time.

11. The database structure of claim 1, wherein the at least one local shift time and the anchor shift time are expressed in a format selected from the group consisting of an integer format, a floating point format, an octal format, a hexadecimal format, a binary format, a character format, and combinations thereof.

12. A method of generating a timezone database structure, comprising the steps of:
generating at least one timezone identifier;
generating at least one local shift time associated with each said timezone identifier; and
generating an anchor shift time associated with each said local shift time.

13. The database structure of claim 12, wherein the steps of generating at least one local shift time and generating an anchor shift time include executing a Local/Anchor Shift Time (LAST) algorithm.

14. The database structure of claim 12, wherein the step of generating at least one local shift time includes causing the at least one local shift time to be in sorted order.

15. The database structure of claim 12, wherein the step of generating at least one local shift time includes causing the at least one local shift time to be in unsorted order.

16. The method of claim 12, wherein a timezone associated with a timezone identifier of the at least one timezone identifier is non-observing.

17. The method of claim 12, wherein a timezone associated with a first timezone identifier of the at least one timezone identifier is observing.

18. The method of claim 17, wherein a timezone associated with a second timezone identifier of the at least one timezone identifier is non-observing.

19. The method of claim 12, wherein a first local shift time associated with a first timezone identifier of the at least one timezone identifier is relative to a reference date-time.

20. The method of claim 19, wherein the first local shift time is after the reference date-time.

21. The method of claim 19, wherein the first local shift time is before the reference date-time.

22. The method of claim 21, wherein a second local shift time associated with the first timezone identifier is relative to the reference date-time, and wherein the second local shift time is after the reference date-time.

23. The method of claim 12, wherein the steps of generating at least one local shift time and generating an anchor shift time comprise expressing the at least one local shift time and the anchor shift time in a format selected from the group consisting of an integer format, a floating point format, an octal format, a hexadecimal format, a binary format, and a character format.

24. The method of claim 12, wherein the steps of generating at least one timezone identifier, generating at least one local shift time, and generating an anchor shift time include adding a new timezone identifier and associated local shift time data and associated anchor shift time data.

25. The method of claim 12, wherein the steps of generating at least one timezone identifier, generating at least one local shift time, and generating an anchor shift time include deleting a new timezone identifier and associated local shift time data and associated anchor shift time data.

26. The method of claim 12, wherein the step of generating at least one local shift time and generating an anchor shift time include adding a local shift time and an associated anchor shift time for an existing timezone identifier of the at least one timezone identifier.

27. The method of claim 12, wherein the steps of generating at least one timezone identifier, generating at least one local shift time, and generating an anchor shift time include:
replacing a timezone identifier that exists in the timezone database structure with a replacement timezone identifier,
replacing a local shift time that exists in the timezone database structure with a replacement local shift time,
replacing an anchor shift time that exists in the timezone database structure with a replacement anchor shift time, or
combinations thereof.

28. A method of using a timezone database structure to perform a timezone-related calculation, comprising the steps of:
providing the timezone database structure which includes at least one timezone identifier, at least one local shift time associated with each said timezone identifier, and an anchor shift time associated with each said local shift time; and
performing the timezone-related calculation utilizing the timezone database structure.

29. The method of claim 28, wherein the performing step includes utilizing a Local Time Conversion (LTC) algorithm to convert a local time of a first timezone to a corresponding local time of a second timezone, and wherein the first timezone and the second timezone each have a timezone identifier that is included in the timezone database structure.

30. The method of claim 29, wherein the first timezone is observing and the second timezone is observing.

31. The method of claim 29, wherein the first timezone is observing and the second timezone is non-observing, or wherein the first timezone is non-observing and the second timezone is observing.

32. The method of claim 29, wherein the first timezone is non-observing and the second timezone is non-observing.

33. The method of claim 28, wherein the performing step includes utilizing a Double Time Test (DTT) algorithm to determine whether a given local time in an observing timezone is in double time, and wherein the observing timezone has a timezone identifier that is included in the timezone database structure.

34. The method of claim 33, if the DTT algorithm determines that the given local time is in double time, further comprising converting the given local time to an associated anchor time, said converting including use of a double time offset.

35. The method of claim 28, wherein the performing step includes utilizing an Advanced Time Test (ATT) algorithm to determine whether a given date-time of an observing timezone is in Advanced Time, and wherein the observing timezone has a timezone identifier that is included in the timezone database structure.

36. The method of claim 28, wherein the performing step includes utilizing an Lost Time Test (LTT) algorithm to determine whether a given date-time of an observing timezone is in lost time, and wherein the observing timezone has a timezone identifier that is included in the timezone database structure.

37. A computer system for generating a timezone database structure, comprising:
a processor;
an input device coupled to the processor;
an output device coupled to the processor;
a first memory device coupled to the processor;
a second memory device coupled to the processor; and
a computer code stored in the second memory device and executed by the processor, said computer code comprising an algorithm for generating the timezone database structure, said algorithm comprising: generating at least one timezone identifier, generating at least one local shift time associated with each said timezone identifier, and generating an anchor shift time associated with each said local shift time.

38. The computer system of claim 37, wherein the algorithm includes a Local/Anchor Shift Time (LAST) algorithm for said generating the at least one local shift time and the associated anchor shift times.

39. The database structure of claim 37, wherein the algorithm causes the at least one local shift time to be in sorted order.

40. The database structure of claim 37, wherein the algorithm causes the at least one local shift time to be in unsorted order.

41. The computer system of claim 37, wherein a timezone associated with a timezone identifier of the at least one timezone identifier is non-observing.

42. The computer system of claim 37, wherein a timezone associated with a first timezone identifier of the at least one timezone identifier is observing.

43. The computer system of claim 42, wherein a timezone associated with a second timezone identifier of the at least one timezone identifier is non-observing.

44. The computer system of claim 37, wherein the algorithm generates a first local shift time associated with a first timezone identifier of the at least one timezone identifier, and wherein the first local shift time is relative to a reference date-time.

45. The computer system of claim 44, wherein the first local shift time is after the reference date-time.

46. The computer system of claim 44, wherein the first local shift time is before the reference date-time.

47. The computer system of claim 46, wherein the algorithm generates a second local shift time associated with the first timezone identifier, and wherein the second local shift time is relative to and after the reference date-time.

48. The computer system of claim 37, wherein the algorithm expresses the at least one local shift time and the anchor shift time in a format selected from the group consisting of an integer format, a floating point format, an octal format, a hexadecimal format, a binary format, and a character format.

49. The computer system of claim 37, wherein generating at least one timezone identifier, generating at least one local shift time, and generating an anchor shift time include adding a new timezone identifier and associated local shift time data and associated anchor shift time data.

50. The computer system of claim 37, wherein generating at least one timezone identifier, generating at least one local shift time, and generating an anchor shift time include deleting a new timezone identifier and associated local shift time data and associated anchor shift time data.

51. The computer system of claim 37, wherein generating at least one local shift time and generating an anchor shift time include adding a local shift time and an associated anchor shift time for an existing timezone identifier of the at least one timezone identifier.

52. The computer system of claim 37, wherein generating at least one timezone identifier, generating at least one local shift time, and generating an anchor shift time include:
replacing a timezone identifier that exists in the timezone database structure with a replacement timezone identifier,
replacing a local shift time that exists in the timezone database structure with a replacement local shift time,
replacing an anchor shift time that exists in the timezone database structure with a replacement anchor shift time, or
combinations thereof.

53. A computer system for using a timezone database structure to perform a timezone-related calculation, comprising:
a processor;
an input device coupled to the processor;
an output device coupled to the processor;
a first memory device coupled to the processor;
a second memory device coupled to the processor;
the timezone database structure coupled to the processor, said timezone database structure comprising: generating at least one timezone identifier, generating at least one local shift time associated with each said timezone identifier, and generating an anchor shift time associated with each said local shift time; and
a computer code stored in the first or second memory device and executed by the processor, said computer code comprising at least one algorithm, said algorithm comprising a capability for performing the timezone-related calculation utilizing the timezone database structure.

54. The computer system of claim 53, wherein the at least one algorithm includes a Local Time Conversion (LTC) algorithm to convert a local time of a first timezone to a corresponding local time of a second timezone, and wherein the first timezone and the second timezone each have a timezone identifier that is included in the timezone database structure.

55. The computer system of claim 54, wherein the first timezone is observing and the second timezone is observing.

56. The computer system of claim 54, wherein the first timezone is observing and the second timezone is non-observing, or wherein the first timezone is non-observing and the second timezone is observing.

57. The computer system of claim 54, wherein the first timezone is non-observing and the second timezone is non-observing.

58. The computer system of claim 53, wherein the at least one algorithm includes a Double Time Test (DTT) algorithm to determine whether a given local time in an observing timezone is in double time, and wherein the observing timezone has a timezone identifier that is included in the timezone database structure.

59. The computer system of claim 58, if the DTT algorithm determines that the given local time is in double time, further comprising converting the given local time to an associated anchor time, said converting including use of a double time offset.

60. The computer system of claim 53, wherein the at least one algorithm includes an Advanced Time Test (ATT) algorithm to determine whether a given date-time of an observing timezone is in Advanced Time, and wherein the observing timezone has a timezone identifier that is included in the timezone database structure.

61. The computer system of claim 53, wherein the at least one algorithm includes an Lost Time Test (LTT) algorithm to determine whether a given date-time of an observing timezone is in lost time, and wherein the observing timezone has a timezone identifier that is included in the timezone database structure.

62. A computer program product, comprising a computer usable medium having a computer readable program code embodied therein, wherein the computer readable program code comprises an algorithm which generates a timezone database structure, said algorithm comprising: generating at least one timezone identifier, generating at least one local shift time associated with each said timezone identifier, and generating an anchor shift time associated with each said local shift time.

63. The computer program product of claim 62, wherein the algorithm includes a Local/Anchor Shift Time (LAST) algorithm for said generating the at least one local shift time and the associated anchor shift times.

64. A computer program product, comprising a computer usable medium having a computer readable program code embodied therein, wherein the computer readable program code comprises an algorithm which uses a timezone database structure to perform a timezone-related calculation.

65. The computer program product of claim 64, wherein the algorithm is selected from the group consisting of a Local Time Conversion (LTC) algorithm, a Double Time Test (DTT) algorithm, an Advanced Time Test (ATT) algorithm, an Lost Time Test (LTT) algorithm, and combinations thereof.
